(19) United States
(12) Patent Application Publication
(10) Pub. No.: US 2026/0189606 A1
(43) Pub. Date: Jul. 2, 2026

(54) METADATA DRIVEN FRAMEWORK FOR DEVELOPING INTEGRATION CONNECTORS IMPLEMENTING CUSTOM LOGIC IN SECURITY POLICIES

(71) Applicant: Oracle International Corporation, Redwood Shores, CA (US)

(72) Inventors: Anuj Kaushal, Noida (IN); Sumit Aneja, Haridwar (IN)

(21) Appl. No.: 19/004,524

(22) Filed: Dec. 30, 2024

(51) Int. Cl. H04L 9/40

(52) U.S. Cl. CPC H04L 63/20; H04L 63/102

(57) ABSTRACT

An aspect of the present disclosure facilitates development of integration connectors. In one embodiment, a digital processing system receives a metadata corresponding to a security policy for accessing a target component, the metadata specifying a respective set of actions to be performed for each flow of a pre-defined set of flows for implementing the security policy. The system inspects the metadata to identify the respective set of actions and forms software instructions corresponding to the respective sets of actions. The system then generates an integration connector incorporating the software instructions, such that the integration connector, when operative, implements the security policy in accessing the target component.

### BACKGROUND OF THE DISCLOSURE

### Technical Field

The present disclosure relates to server computing and more specifically to a metadata driven framework for developing integration connectors implementing custom logic in security policies.

### Related Art

Integration connectors refer to intermediate software components that facilitate an application/data service to connect and interface (send/receive data) with other applications, data services, data sources, devices, etc., (target components) according to pre-specified conventions. Integration connectors typically abstract the application programming interfaces (APIs), message formats, security interfaces and other aspects of the target components. Accordingly, integration connectors act as front-ends to the target components and simplify how applications, technologies and processes can be integrated to implement desired workflows.

Frameworks are often used for developing integration connectors. In one embodiment described herein, the framework generates software code that constitutes a desired integration connector. Such frameworks may be driven by metadata, implying various aspects of the generated software code are determined by the metadata. The metadata may specify aspects such as the identity/type of the target component, communication parameters, etc., with the framework generating the software code, which when operative, provides the abstraction noted above.

The software code thus generated typically implements various security policies suitable for the corresponding target component. As is well known, a security policy generally specifies the high-level requirements/procedures (such as the form of requests to be sent and the manner in which the corresponding responses are to be interpreted) to be followed to access the target component.

Frameworks are typically designed to generate software code corresponding to many of the well-known security policies. For example, when the metadata specifies that a target component uses OAUTH protocol, a framework automatically generates software code (integration connector) that is operative to perform authentication of the user, create a token based on authorization by an owner of a resource sought to be accessed, and to thereafter enclose the created token in each subsequent access request for the resource.

However, there may be scenarios in which a target component requires a new security policy, which is different from well-known security policies. Such a new security policy specifies a different set of requirements/procedures (i.e., custom logic in terms of the requests/responses noted above), not readily supported by the framework.

Aspects of the present disclosure are directed to providing a metadata driven framework for developing integration connectors implementing custom logic in security policies.

### BRIEF DESCRIPTION OF THE DRAWINGS

Example embodiments of the present disclosure will be described with reference to the accompanying drawings briefly described below.

FIG. 1 is a block diagram illustrating an example computing environment in which several aspects of the present disclosure can be implemented.

FIG. 2 is a block diagram illustrating the manner in which integration connectors are provided in one embodiment.

FIG. 3 is a flow chart illustrating the manner in which a metadata driven framework for developing integration connectors implementing custom logic in security policies is provided according to aspects of the present disclosure.

FIG. 4 depicts the different types of security properties available in one embodiment.

FIG. 5 depicts the pre-defined flows in one embodiment.

FIGS. 6A-6C together illustrates the manner in which metadata for an integration connector implementing a custom security policy is specified in one embodiment.

FIG. 7 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates development of integration connectors. In one embodiment, a digital processing system receives a metadata corresponding to a security policy for accessing a target component, the metadata specifying a respective set of actions to be performed for each flow of a pre-defined set of flows for implementing the security policy. The system inspects the metadata to identify the respective set of actions and forms software instructions corresponding to the respective sets of actions. The system then generates an integration connector incorporating the software instructions, such that the integration connector, when operative, implements the security policy in accessing the target component.

According to one more aspect of the present disclosure, the system identifies one or more security properties specified in the metadata, each security property being specified associated with a corresponding persistence scope. The system then ensures that any update to the one or more security properties in the pre-defined set of flows specified by the metadata is consistent with the corresponding persistence scope. The system also enforces that respective values of the one or more security properties are stored based on the corresponding persistence scope when the integration connector is operative.

According to yet another aspect of the present disclosure, the pre-defined set of flows includes an initialization flow, a provide consent flow, a provide consent callback flow, a validate context flow, an update ephemerals flow, and an apply flow.

According to an aspect of the present disclosure, the security policy is token-based. The provide consent flow and the provide consent callback flow facilitate generation of a token, while the validate context flow and the update ephemerals flow facilitate management of the token, and the apply flow injects the token in each request sent by the integration connector to the target component.

According to another aspect of the present disclosure, the corresponding persistence scope is one of a connection scope, a request scope and a session scope. For ensuring (noted above), the system checks that security properties associated with only the request scope or the session scope are updated in the update ephemerals flow, and that no security properties are updated in the apply flow.

According to one more aspect of the present disclosure, for enforcing (noted above), the system creates one or more instructions, which when operative, causes the respective values of the one or more security properties associated with the connection scope to be stored in a vault, and those associated with the session scope to be stored in an ephemeral store. The system incorporates the one or more instructions in the integration connector.

According to yet another aspect of the present disclosure, each security property is one of: a fixed type whose value is pre-defined by a connector developer; an inferred type whose value is determined based on other security properties; an input type whose value is provided by an integration developer; a volatile type whose value is computed afresh for each request; and an ephemeral type whose value is to be refreshed after every expiry duration. The fixed type, the inferred type and the input type are associated with the connection scope, the volatile type is associated with the request scope, and the ephemeral type is associated with the session scope.

According to another aspect of the present disclosure, for forming (noted above), the system maintains a library of functions, each function being associated with a corresponding function identifier. Upon determining a set of function identifiers specified in the respective set of actions, the system includes in the software instructions, functions corresponding to the set of function identifiers.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

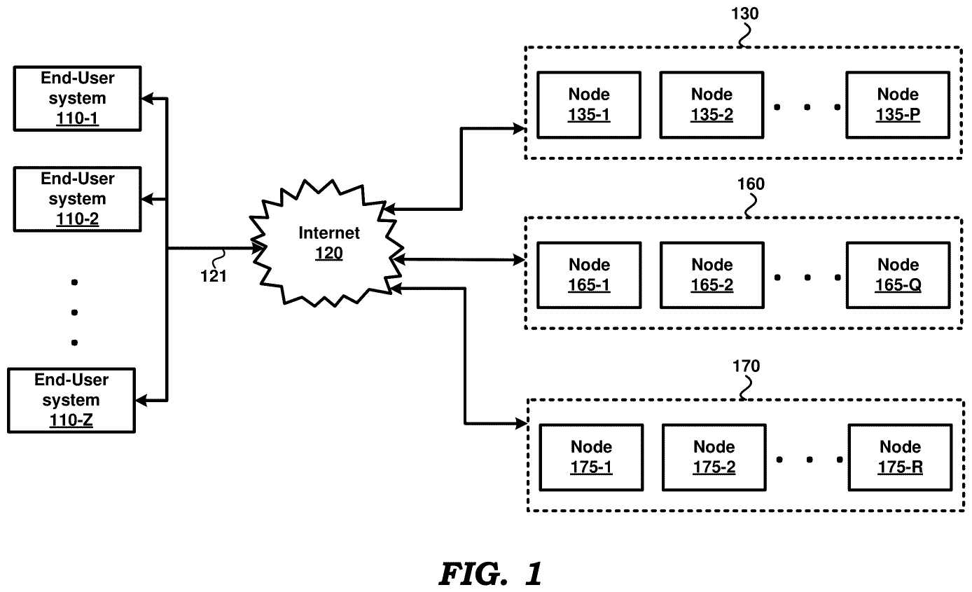

FIG. 1 is a block diagram illustrating an example computing environment in which several aspects of the present disclosure can be implemented. The block diagram is shown containing end-user systems 110-1 through 110-Z (Z representing any natural number), Internet 120, and computing infrastructures 130, 160 and 170. Computing infrastructure 130 in turn is shown containing nodes 135-1 through 135-P (P representing any natural number). Computing infrastructure 160 in turn is shown containing nodes 165-1 through 165-Q (Q representing any natural number). Computing infrastructure 170 in turn is shown containing nodes 175-1 through 175-R (R representing any natural number). The end-user systems and nodes are collectively referred to as 110, 135, 165 and 175 respectively.

Merely for illustration, only representative number/type of systems are shown in FIG. 1. Many environments often contain many more systems, both in number and type, depending on the purpose for which the environment is designed. Each block of FIG. 1 is described below in further detail.

Each of computing infrastructures 130, 160 and 170 is a collection of physical processing nodes (135, 165 and 175), connectivity infrastructure, data storages, administration systems, etc., which are engineered to together host application/data services. For illustration, the aspects of the present disclosure are described below with respect to application services, though the same aspects can be applied to data services as well as will be apparent to one skilled in the relevant arts by reading the disclosure herein.

Computing infrastructure 130/160/170 may be a cloud infrastructure such as Amazon Web Services (AWS) available from Amazon. com, Inc., Azure available from Microsoft Corporation, Google Cloud Platform (GCP) available from Google LLC, Oracle Cloud Infrastructure (OCI) available from Oracle Corporation, etc. that provides a virtual computing infrastructure for various customers/tenants, with the scale of such computing infrastructure being specified often on demand. Alternatively, computing infrastructures 130/160/170 may also correspond to an enterprise system (or a part thereof) on the premises of the customers (and accordingly referred to as “On-prem” infrastructure). Computing infrastructures 130/160/170 may also be a “hybrid” infrastructure containing some nodes of a cloud infrastructure and other nodes of an on-prem enterprise system.

All the systems of each computing infrastructures 130/160/170 are assumed to be connected via a corresponding intranet (not shown). Internet 120 extends the connectivity of these (and other systems of the computing infrastructures) with external systems such as end-user systems 110. Each of the intranets (not shown) and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and respective intranet. When the packet contains content such as port numbers, which specifies a target application, the packet may be said to be directed to such application as well.

Each of end-user system 110 represents a system such as a personal computer, workstation, mobile device, computing tablet, etc., used by users to generate (user) requests directed to application services executing in computing infrastructures 130/160/170. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system 110 requests an application service for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or application service, with the IP packet including data identifying the desired tasks in the payload portion.

Some of nodes 135/165/175 may be implemented as corresponding data stores. Each data store represents a non-volatile (persistent) storage facilitating storage and retrieval of data by application services executing in the other systems/nodes of computing infrastructures 130/160/170. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 135/165/175 may be implemented as corresponding server systems. Each server system represents a server, such as a web/application server, constituted of appropriate hardware, executing application/data services capable of performing one or more tasks. The tasks may be specified as part of user requests received from end-user systems 110 or node requests received from nodes of same/other cloud infrastructures.

A server system, in general, receives a task request (user request or node request) and performs the tasks requested in the task request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting system (end-user system 110 or node 135/165/175) as a corresponding response to the task request. The results may be accompanied by specific user interfaces (e.g., web pages) for displaying the results to a requesting user.

It may be necessary or desirable for application services (source components) executing in various nodes (135/165/175) to connect and interface with other application services, data services, data sources, devices, etc. (target components) deployed in other nodes of computing infrastructures 130/160/170. Integration connectors facilitate such interfacing between application services as described below with examples.

### 3. Integration Connectors

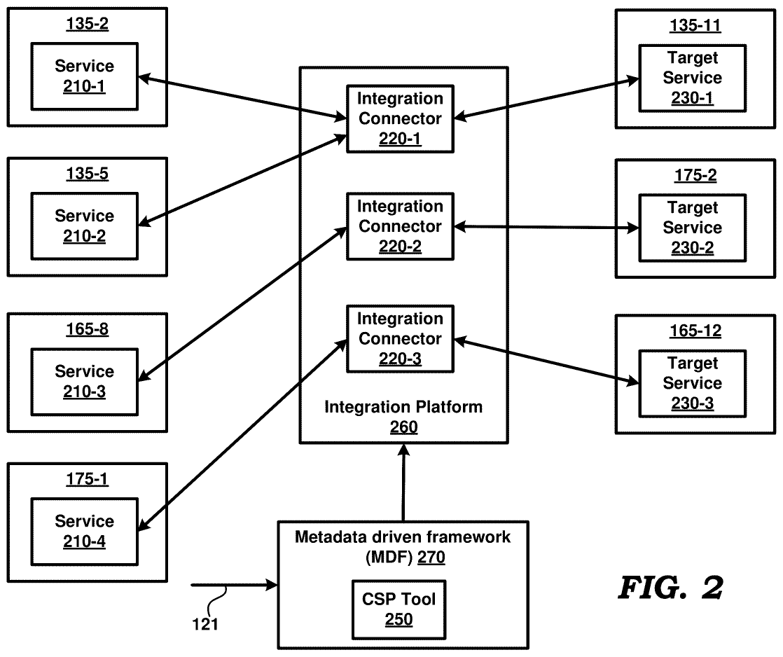

FIG. 2 is a block diagram illustrating the manner in which integration connectors are operative in one embodiment. The block diagram is shown containing services 210-1 to 210-4, target services 230-1 to 230-3, integration platform 260 (in turn shown containing integration connectors 220-1 to 220-3), and metadata driven framework (MDF) 270 (in turn shown containing custom security policy (CSP) tool 250). Each block of the Figure is described below in further detail.

Each of services 210-1 to 210-4 and target services 230-1 and 230-3 represent application/data services deployed in various nodes (135/165/175) of computing infrastructures 130/160/170. Services 210-1 to 210-4 represent source components that need to connect and interface with target services 230-1 and 230-3 (target components). Integration connectors 220-1 to 220-3 facilitate such interfacing between services 210-1 to 210-4 and target services 230-1 to 230-3.

Specifically, integration connector 220-1 represents an intermediate software component that facilitate source components (services) to interface with target service 230-1. As such, integration connector 220-1 abstracts the application programming interfaces (APIs), message formats, security and other aspects of target service 230-1, and accordingly, acts as a front-end to target service 230-1. Integration connection 220-1 receives requests from services 210-1 and 210-2, performs any desired operations such as data mapping, data conversion, etc., invokes the appropriate interfaces of target service 230-1, receives the corresponding responses, and provides appropriate responses to services 210-1 and 210-2. Similarly, integration connector 220-2 facilitates the interfacing between service 210-3 and target service 230-2, while integration connector 220-3 facilitates the interfacing between service 210-4 and target service 230-3.

Integration platform 260 represents a software platform that hosts and executes integration connectors (such as 220-1 to 220-3). The software platform, typically hosted on nodes 135/165/175, is designed to provide appropriate environment(s) for execution of the integration connectors. It should be noted that integration platform 260 typically hosts a large number (100+) of integration connectors.

In one embodiment, integration platform 260 is an integration-Platform-as-a-Service (iPaaS) that is deployed (as a cloud) deployed in computing infrastructures 130/160/170. The iPaaS platform facilitates customers/tenants in the management (hosting, execution, update, etc.) of their integration connectors (also referred to as “adapters”). The adapters of an iPaaS platform enable an application/data service to interface with on-premise systems, cloud applications, cloud data sources, cloud computing clusters, Internet of Things (IoT) devices, etc. as is well known.

In the following disclosure, it is assumed for illustration that integration platform 260 is implemented as a cloud-based service in computing infrastructure 130, with integration connectors being deployed and executing in nodes 135. An example of the such an iPaaS platform (260) is Oracle Integration Cloud Service Release 16.3.1 available from Oracle International Corporation, the assignee of the instant application.

Metadata driven framework (MDF) 270 represents a software framework that assists users to develop desired integration connectors. Specifically, MDF 270 is designed to receive (via path 121) metadata from users/developers using end-user systems 110, and to generate software instructions corresponding to the received metadata. In the following disclosure, “connector developer” refers to a user (of the platform or third-party provider) specifying the metadata corresponding to the integration connector, while “integration developer” refers to a user (of the customer/tenant) using the integration connector as part of an integration workflow. An example of such a metadata driven framework (270) is RAB (Rapid Adapter Builder) available from Oracle International Corporation, the assignee of the instant application.

It may be appreciated that MDF 270 (such as RAB) may support several out-of-the-box managed security policies which have been implemented as a part of the cloud hosted on computing infrastructures 130/160/170. The managed policies can be used declaratively and customized to a certain extent, if need be. While such implementations may cover a wide variety of popular/well-known security policies, it may be appreciated that such pre-built policies are still not sufficient when target components use custom and proprietary security mechanisms to protect public endpoints.

Accordingly, customers/tenants may need to create new integration connectors implementing desired custom logic in security policies. In the following disclosure, the term “custom security policy” refers to a security policy requiring custom logic/proprietary logic. It is also assumed that target service 230-3 is a target component that requires a custom security policy (e.g., custom digital signature), and accordingly an object of the present disclosure is to generate integration connector 220-3 that implements the custom security policy and thereby enables source components (such as 210-4) to interface with target service 230-3.

It may be appreciated that expecting the customers/tenants and third party providers to implement such integration connectors (220-3) implementing custom security policies is neither practical (creating code modules for execution in integration platform 260 is not simple) or secure (the code modules may cause the security of integration platform 260 to fail). As such, it may be imperative to allow customers to define and implement desired custom logic based security policies through a metadata driven language that executes in a bounded context.

Custom security policy (CSP) tool 250, provided according to several aspects of the present disclosure, represents a metadata driven framework for developing integration connectors implementing custom logic in security policies. Though shown as a part of MDF 270, in alternative embodiments, CSP tool 250 may be implemented as a separate component executing on one of nodes 135/165/175, as will be apparent to one skilled in the relevant arts by reading the disclosure herein. The manner in which CSP tool 250 facilitates the development of integration connectors implementing custom security policies is described below with examples.

### 4. Developing Integration Connectors Implementing Custom Security Policies

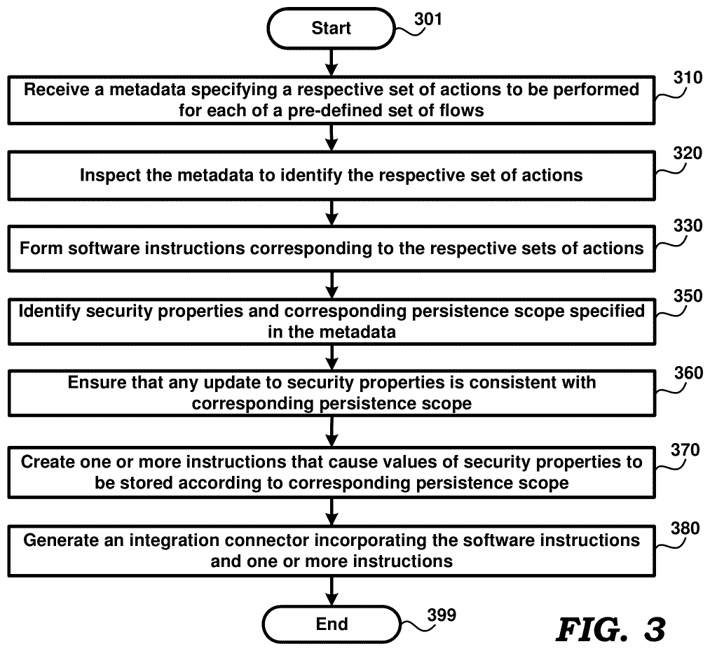

FIG. 3 is a flow chart illustrating the manner in which a metadata driven framework for developing integration connectors implementing custom logic in security policies is provided according to aspects of the present disclosure. The flowchart is described with respect to the systems of FIGS. 1 and 2, in particular CSP tool 250, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 310.

In step 310, CSP tool 250 receives a metadata specifying a respective set of actions to be performed for each (flow) of a pre-defined set of flows. The received metadata corresponds to a (custom) security policy for accessing a target component (230-3). According to an aspect, the pre-defined set of flows includes an initialization flow, a provide consent flow, a provide consent callback flow, a validate context flow, an update ephemerals flow, and an apply flow.

The metadata may be received from a connector developer using one of end-user systems 110. The connector developer may specify the metadata using appropriate user interfaces, as will be apparent to one skilled in the relevant arts. The metadata may be according to a pre-defined schema. In one embodiment, the metadata is in the form of an adapter definition document (ADD) specified according to a JSON (JavaScript Object Notation) schema pre-defined by RAB.

In step 320, CSP tool 250 inspects the metadata to identify the respective set of actions. Such inspecting may entail parsing the syntax of the received metadata based on the pre-defined schema to identify the respective set of actions. In one embodiment, each of the pre-defined flows is associated with a corresponding flow identifier (e.g., “applyFlow”) in the schema, and the specification of each action is associated with a keyword (e.g., “action”). As such, CSP tool 250 determines the occurrences of the keyword associated with a flow identifier as the respective set of actions to be performed for the pre-defined flow identified by the flow identifier.

In step 330, CSP tool 250 forms software instructions corresponding to the respective sets of actions. Forming may entail converting each action into one or more software instructions consistent with an environment provided by integration platform 260, as is well known in the relevant arts. In one embodiment, the software instructions are according to any programming language (such as C#, F#, etc.) supported by Visual Studio available from Microsoft Corporation.

According to an aspect, CSP tool 250 maintains a library of functions, with each function being associated with a corresponding function identifier. CSP tool 250 then determines a set of function identifiers specified in the respective set of actions, and includes in the software instructions, the functions corresponding to the set of function identifiers.

In step 350, CSP tool 250 identifies security properties and corresponding persistence scope specified in the metadata. In the disclosure herein, the term “security property” refers to an identifier/name that is associated with a corresponding fixed/variable value. Example of such security properties are signature, signatureLocation, signKey, token, username, password, etc.

The identification may be performed similar to step 320, based on occurrences of specific keywords in the metadata, as described in the below sections. According to an aspect, the persistence scope of each security property is one of a connection scope, a request scope and a session scope. Any other value for persistence scope may also be used based on the environment provided by integration platform 260.

According to another aspect, each security property is one of a fixed type whose value is pre-defined by a connector developer; an inferred type whose value is determined based on other security properties; an input type whose value is provided by an integration developer; a volatile type whose value is computed afresh for each request; and an ephemeral type whose value is to be refreshed after every expiry duration. The persistence scope for each of fixed type, inferred type and input type is connection scope, that of volatile type is request scope, and that of ephemeral type is session scope.

In step 360, CSP tool 250 ensures that any update to security properties is consistent with corresponding persistence scope. According to an aspect, CSP tool 250 checks that security properties associated with only request scope or session scope are updated in the update ephemerals flow, and that no security properties are updated in the apply flow. Such a check ensures that the security properties are not updated out of context, which may result in error or security issues during operation.

In step 370, CSP tool creates one or more (software) instructions (when operative) that cause values of security properties to be stored according to corresponding persistence scope. According to an aspect, the created one or more instructions, when operative, causes the respective values of security properties associated with connection scope to be stored in a vault, and those associated with session scope to be stored in an ephemeral store. It may be appreciated that when operative, the creates instructions ensures that any misuse of storages (e.g. using vault for storing volatile/ephemeral type properties) is prevented.

In step 380, CSP tool 250 generates an integration connector (220-3) incorporating the software instructions (formed in step 330) and one or more (software) instructions (created in step 370). The generated integration connection (220-3) when operative (in integration platform 260) implements the custom security policy in accessing the target component 230-3.

It may be appreciated that additional software instructions may be incorporated to make the integration connector suitable for operation in the environment provided by integration platform 260. Also, generation may entail converting the software instructions from the programming language (noted above) to an executable format (e.g., binary, bytecode) consistent with the environment provided by integration platform 260, as will be apparent to one skilled in the relevant arts. Control passes to step 399, where the flowchart ends.

Thus, CSP tool 250 provides a metadata driven framework for developing integration connectors implementing custom logic in security policies. According to an aspect, the security policy is token-based, with the provide consent flow and the provide consent callback flow facilitating generation of a token, while the validate context flow and the update ephemerals flow facilitate management of the token. The apply flow injects the token in each request sent by the integration connector (220-3) to the target component (230-3).

The manner in which CSP tool 250 provides several aspects of the present disclosure according to the steps of FIG. 3 is described below with examples.

### 5. Illustrative Example

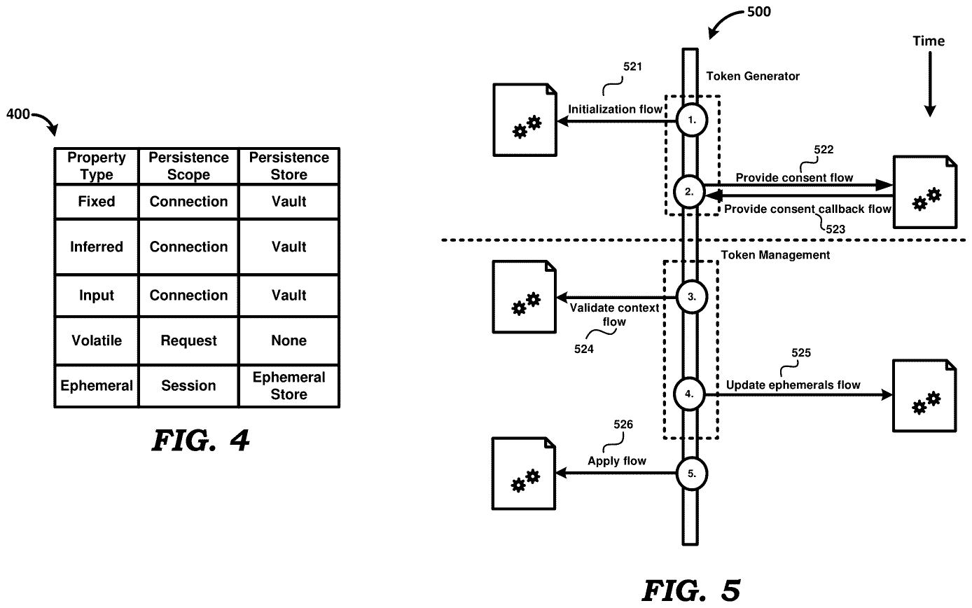

FIGS. 4, 5, and 6A-6C together illustrate the manner in which a metadata driven framework for developing integration connectors implementing custom logic in security policies is provided in one embodiment. Each of the Figures is described in detail below.

FIG. 4 depicts the different types of security properties available in one embodiment. The security types are shown in the form of a table (400) for illustration. In table 400, column “Property Type” indicates a name for the type, column “Persistence Scope” indicates a persistence scope that is associated with the type, and column “Persistence Store” indicates a storage in which a value for the type is to be stored/maintained (with “None” indicating that the value is not to be persisted). Each of the security property types (rows) in table 400 is described in detail below.

Fixed type security properties have fixed pre-defined values (which is a literal) provided by a connector developer and are marked as hidden from the integration developer. The fixed type security properties are associated with connection scope and are required to be stored in a vault. It should be noted that “vault” here refers to any secured non-volatile storage such as HashiCorp Vault available from HashiCorp Corporation. Examples of such fixed type security properties are accessTokenURI (fixed and public).

Inferred type security properties have values that can be determined based on (values of) other security properties. The inferred types do not have a fixed value but have a value that can be inferred by combining (e.g. using JQ expressions, well known in the arts) one or multiple other security properties. These properties are marked as hidden from the integration developer. The inferred type security properties are associated with connection scope and are required to be stored in the vault. Examples of such inferred type security properties are tenant specific accessTokenURI (depends on tenantID security/connection property).

Input type security properties have values that are provided by an integration developer. Such properties are required to be input by the integration developer as part of the connection form, and accordingly must not be marked hidden (as they need to be visible in the console). The input type security properties are associated with connection scope and are required to be stored in the vault. Examples of such input type security properties are Username, Password.

Volatile type security properties have values that are computed afresh for each request. Such properties are typically inferred dependent upon multiple other factors like the runtime request message. The volatile type security properties are associated with request scope and are not persisted. There is no point in caching/persisting such properties as these properties are not re-usable and must be computed afresh every time. Examples of such volatile type security properties are Signature.

Ephemeral type security properties have values that are refreshed after every expiry duration. Such are typically also inferred, with the inferred value having an expiry duration (e.g., 60 seconds, 5 minutes, etc.). The inferred value can be reused in that timeframe, but has to be recomputed once the timeframe has expired. These properties are associated with a session scope, and cannot be stored in the vault due to the ephemeral nature. Instead, ephemeral type security properties are stored in an “Ephemeral store”, which refers to any temporary storage that is available for a duration. Examples of such ephemeral type security properties are oauth2.accessToken, oauth2.refreshToken, etc.

It may be appreciated that a connector developer may specify multiple security properties of the desired security types (shown in table 400) in the metadata for developing an integration connector implementing custom logic. The specified security properties may be updated as part of the pre-defined flows. The set of pre-defined flows provided/required by CSP tool 250 is described below with examples.

### 6. Pre-defined Flows

FIG. 5 depicts the pre-defined flows in one embodiment. Broadly, the pre-defined security flows are defined using CNCF (Cloud Native Computing Foundation) flow grammar. Each security flow may use one or more pre-defined security properties. These security properties may be read to perform certain steps and can also be used to store outcomes of one or more steps.

Timeline 500 depicts the chronological sequence of the various pre-defined flows. It may be appreciated that the pre-defined flows together cover the different phases of the life-cycle of a security policy. Timeline 500 is shown containing initialization flow 521, provide consent flow 522, provide consent callback flow 523, validate context flow 524, update ephemerals flow 525, and apply flow 526. Each of the (security) flows is described in detail below.

Initialization flow 521 happens during the initialization of a security policy. This flow must happen during design time when the connector developer configures a connection. As this flow happens at design time, as a first step, before provide consent flow (if present) or before test connection (otherwise), the resource owner (having authorization rights of target component) is available to participate in this flow, if required. The resource owner may be used to perform, for example, user input validation, other preliminary calls, etc.

It may be appreciated that the initialization flow (521) must be kept to a minimum and cover only those steps that are required at design time. If the actions performed at design time are same as the actions performed at runtime, then the initialization flow should be kept blank to avoid duplication. For example, OAuth2 client credentials, as per rfc6749, oauth2 client credentials must not support a refresh mechanism. Thus essentially, the same steps are performed on expiry and also at the first time while configuring the connection.

Initialization flow can update all the security properties irrespective of their persistence scope. At the minimum, initialization flow 521 securely persists the user-input and all the other properties that have a connection scope.

Provide consent flow 522 is applicable only if a resource owner mediation is required (as part of the custom security policy) for accessing the target component. On initiation, an authorization URL is computed using a CNCF workflow. The resource owner is redirected to the authorization server via a user agent to mediate. It should be noted that provide consent callback flow 523 needs to be associated which will be called based on the outcomes of mediation.

Provide consent callback flow 523 is applicable if resource owner mediation is required. An onEvent callback is received from the user agent after the resource owner performs a mediation action as part of provide consent flow 522. This flow is then used to validate and extract the relevant information from the callback response received. The extracted information can then be assigned to one or more security properties with relevant persistence scope for rest of the steps.

Validate (security) context flow 524 is used to validate a current security context. Security context may be valid for a limited duration/time frame, especially in the context of ephemeral tokens. As such, this flow is required typically as a precursor to the next phase update ephemerals flow 525 and used to establish if the existing ephemeral tokens cached need to be updated or they can be simply re-used. If omitted (that is no validate context flow 524 is specified), the update ephemerals flow 525 is not called/invoked.

For example, for a sample ephemeral access token {“token”: “asdfatatat==”, “expiry”: 3600, “creationTime”: “1690359688”}, a connector developer may choose to deploy a JQ expression to compare the difference between the current time and the creation time to figure if the token has expired or not.

Update ephemerals flow 525 (also referred to as refresh flow) is used to procure or refresh reusable ephemeral tokens. The procurement or refresh of ephemeral tokens must not involve resource owner interaction at this point. This flow is used for continuity in automated workflows and thus all steps that require user intervention must be restricted to initialization flow 521 and provide consent flow 522. Update ephemerals flow 525 typically involves refreshing expired tokens or recomputing signatures or re-procuring expired certificates etc.

Update ephemerals flow 525 must use lower levels of security persistence. Since the update ephemeral tokens flow is used at runtime, highest level (updating the vault) may have consequences if the updates are too frequent. Thus, only update of ephemeral type or volatile type (in other words, request scope or session scope) security properties are permitted in update ephemerals flow 525.

Apply (security) flow 526 is used to define the application of the security information as part of runtime requests. Apply flow 526 is the last phase in the security lifecycle. Typically, this flow involves applying the security information. The actual request is considered immutable when this phase starts because a change in request may render the computed signatures to be invalid. The apply phase can also be considered an overlay flow as it applies the security configuration to requests computed as part of other flows.

A connector developer may specify any desired custom security policy/flow using the different pre-defined (security) flows 521-526. The complete security flow must comprise of all the phases (initialize, refresh, apply) of the lifecycle of a security policy. Along with initialization security flow 521, the complete security flow must be validated upfront for the following reasons:
Initialize phase: The connection configuration is performed by a user/connector developer and if the flow requires resource owner participation to provide consent (as is the case in oauth 2 3-legged flows), then that can be performed.
Provide consent/callback phase: Initiate resource owner mediation and captures the outcomes.
Validate security context phase. Ensure that the current security context is valid.
Update ephemerals phase: It is mandatory to pre-check all the conditions related to the security lifecycle of a policy during connection configuration. A successful connection should imply that the connection will perform successfully at design time and runtime for long running flows.
Apply Security flow: By the end of complete security flow, all the security steps including application of the acquired security information, need to be reliably computed and verified.

Thus, aspects of the present disclosure provide a mechanism that can be used by connector developers to author/develop a new integration connector (security client) from scratch using a metadata framework to connect and authenticate with an end application/target component. The development/authoring of a security client involves a series of steps—a. Defining the user-facing form through which end users (integration developers) have to provide security credentials; b. Defining a workflow involving a series of steps through which connector developers can orchestrate these security credentials to obtain additional security material for invoking the target application/component; and c. Defining workflows for automatically refreshing security material, and if need be, at runtime to procure fresh security material for invoking the target application/component.

It may be appreciated that CSP tool 250 allow users/connector developers to define how and when to collect security credentials and additional material throughout the entire security lifecycle and store the material in an appropriate secure store till relevant. CSP tool 250 also allows users to define how to apply the security material stored in various secure stores. CSP tool 250 adds checks and balances (ensuring updates and enforcing storages) in the system to ensure user defined security workflows do not lead to insecure practices. The manner in which metadata may be specified and thereafter received by CSP tool 250 is described below with examples.

### 7. Sample Metadata

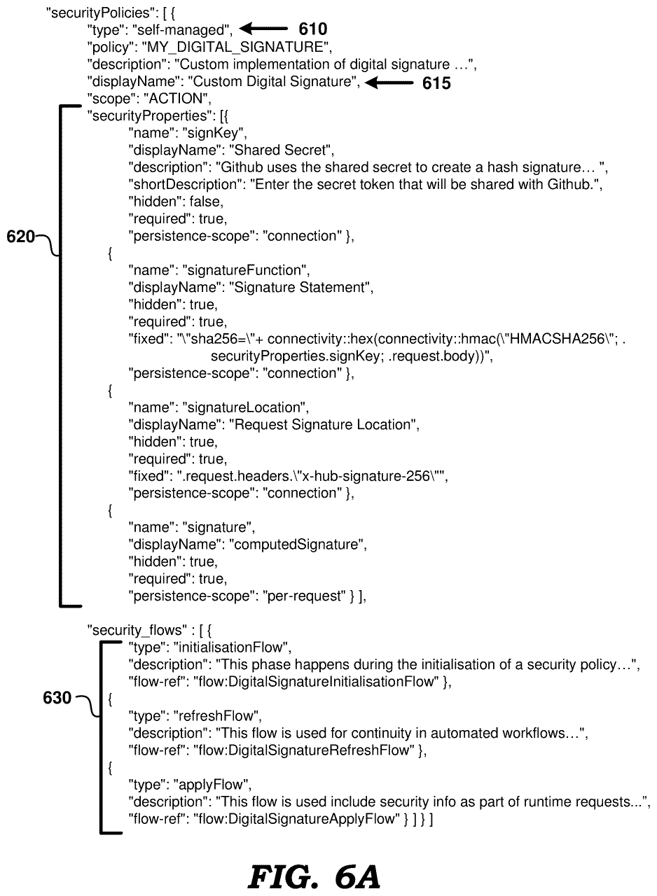

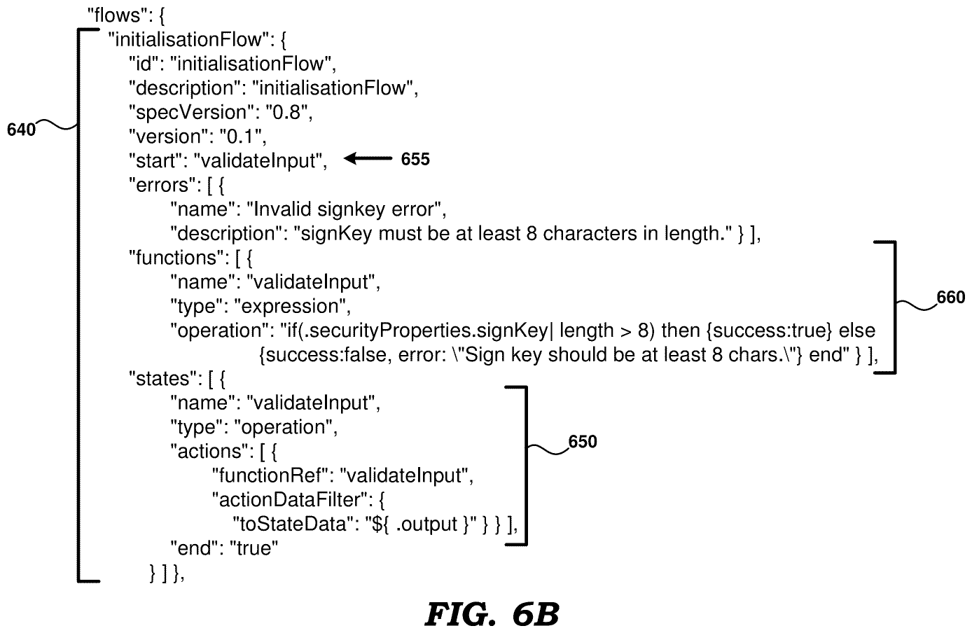

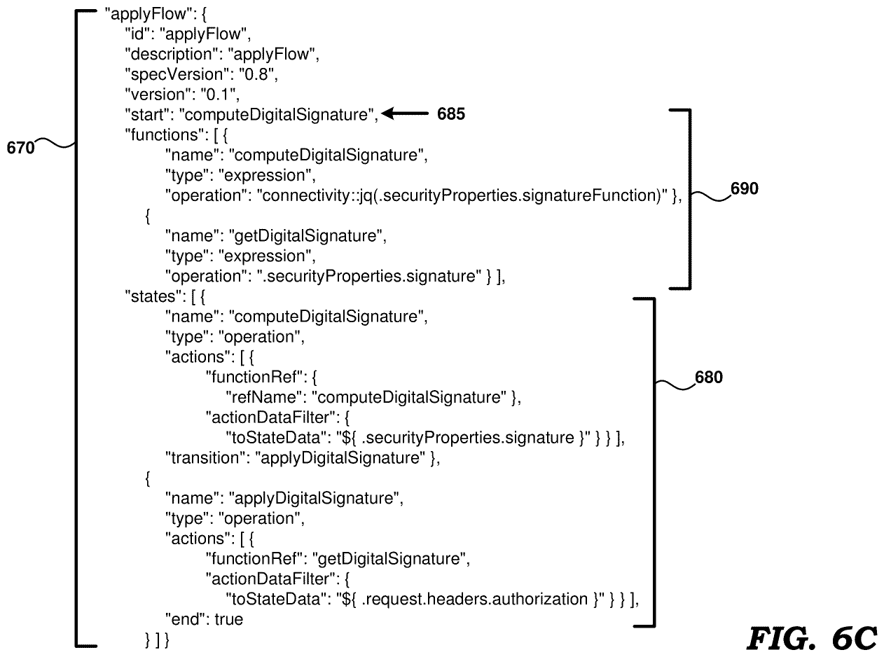

FIGS. 6A-6C together illustrates the manner in which metadata for an integration connector implementing a custom security policy is specified in one embodiment. For illustration, the definition data is shown specified according to JSON (JavaScript Object Notation). However, in alternative embodiments, the setup data may be maintained according to other data formats (such as extensible markup language (XML), etc.) and/or using other data structures (such as database tables, lists, trees, etc.), as will be apparent to one skilled in the relevant arts by reading the disclosure herein.

In FIG. 6A, data portion 610 indicates that the type of the security policy is “self-managed” indicating the user/connector developer is authoring a security policy and will define the security policy properties and flows. Data portion 615 indicates that the custom logic sought to be implemented is a custom digital signature.

Data portion 620 specifies the various security properties to be used as part of the custom security policy. Developers are able to add a security policy with a collection of properties. Each property must be of a defined data type but developers will be able to control the visibility and display name of each property. Visible properties become part of the security policy form that will be visible to integration developers as part of the connection interface.

For example, each security property has a corresponding “name” keyword/attribute, a “hidden” keyword which is set to true if the property needs to be masked from the user/integration developer or and to false if not and a “persistence-scope” that may be set to one of “connection” (to indicate connection scope), “per-request” (request scope) or “session” (session scope).

It may be observed that data portion 620 specifies a security property “signKey” that is not to be hidden, and accordingly is required to be received as input from an integration developer (when the developer uses the generated connector in an integration flow, as will be apparent to one skilled in the relevant arts). It may be also observed that the security property “signatureFunction” is specified to be inferred based on the security property “signKey”. These security properties are used in flows comprising of single or multiple steps to achieve the goals of reliably procuring, saving and refreshing security information and calling protected applications as described in detail below.

Data portion 630 specifies the set of pre-defined flows that are part of the custom security policy. It may be observed that the types of the flows (such as “InitializationFlow”, “ApplyFlow”, etc.) are pre-defined but the actual flows are implemented by the connector developer. Pre-defined flows are enforced during different phases and security property semantics are enforced at each phase.

In FIG. 6B, data portion 640 specifies the set of actions to be performed as part of the initialization flow. Data portion 650 specifies the various states that are to be executed as part of the flow, with each state specifying the actions to be performed (“actions”), the security properties to be updated (“actionDataFilter”), and the next state to which to be transitioned (with “end”: “true” indicating that the state is the end/last state.

Data portion 655 indicates the indicates the start/initial state of the flow to be executed, and accordingly causes the state “validateInput” to be executed, which in turn causes the function “validateInput” defined in data portion 660 to be executed. Data portion 660 defines a function that checks whether the input for the security property “signKey” (provided by an integration developer) is at least 8 characters in length.

Specifically, data portion 660 specifies an “operation” to be performed. Each such operation in the metadata may specify any desired expression according to JQ expression language and may use CNCF/JQ functions. In one embodiment, CSP tool 250 coverts the specified expression into instructions (here, according to C#, F# languages) supported by integration platform 260. Such instructions are incorporated into instructions constituting the integration connector. Alternatively, CSP tool 250 maintains a library of such CNCF/JQ functions, each function being associated with a corresponding function identifier. Upon determining function identifiers specified in the metadata, CSP tool 250 includes in the software instructions (constituting the integration connector), functions corresponding to the set of function identifiers, as will be apparent to one skilled in the relevant arts.

In FIG. 6C, data portion 670 specifies the set of actions to be performed as part of the apply flow, with data portion 680 specifying the various states that are to be executed as part of the flow, and data portion 685 indicating that the start/initial state is “computeDigitalSignature”. It may be observed that data portion 680 indicates that the apply flow has two states “computeDigitalSignature” followed by “applyDigitalSignature”.

In the initial/first state, the function named “computeDigitalSignature” specified in data portion 690 is to be invoked, which in turn retrieves a signature by connecting (using a JQ function) to the location indicated by the security property “signatureFunction”. The retrieved signature is to be updated to the security property named “signature”. In the next state, the function named “getDigitalSignature” is invoked to retrieve the previously stored value for “signature” security property and the retrieved value is injected into the request headers.

Thus, users/connector developers are provided with a flexible approach to author/develop a integration connector implementing custom logic in a security policy. The framework (CSP tool 250) allows users to define security properties and how they will be used. Based on the usage, store the security properties securely in an appropriate storage. The framework also enforces that the properties do not violate the storage and usage semantics.

Such an approach allows customers and partners to control all the aspects of a security policy starting from the user interface, workflows, persistence of security material and application of security material. The metadata driven approach provides a bounded framework with rules for all the steps defined before. The framework associates and enforces persistence semantics with each security policy, while also providing flexibility to write custom security flows securely.

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

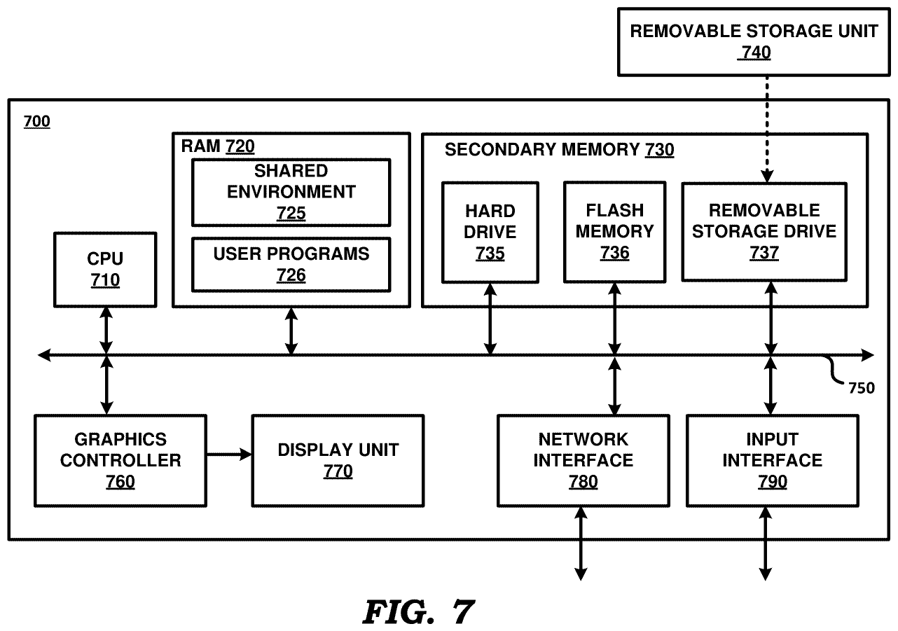

FIG. 7 is a block diagram illustrating the details of digital processing system (1000) in which various aspects of the present disclosure are operative by execution of appropriate executable modules. Digital processing system 700 may correspond to CSP tool 250 or MDF 270 or nodes 135/165/175 implementing integration platform 260.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or other user programs 726 (such as other applications, DBMS, etc.). In addition to shared environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems connected to the networks.

Secondary memory 730 may contain hard drive 735, flash memory 736, and removable storage drive 737. Secondary memory 730 may store the data (e.g., data shown in FIGS. 4, 5 and 6A-6C) and software instructions (e.g., for performing the actions of FIG. 3, for implementing the blocks of FIG. 2), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method for facilitating development of integration connectors, said method comprising:
receiving a metadata corresponding to a security policy for accessing a target component, said metadata specifying a respective set of actions to be performed for each flow of a pre-defined set of flows for implementing said security policy;
inspecting said metadata to identify said respective set of actions;
forming software instructions corresponding to said respective sets of actions; and
generating an integration connector incorporating said software instructions, wherein said integration connector, when operative, implements said security policy in accessing said target component.

2. The method of claim 1, further comprising:
identifying one or more security properties specified in said metadata, each security property being specified associated with a corresponding persistence scope;
ensuring that any update to said one or more security properties in said pre-defined set of flows specified by said metadata is consistent with said corresponding persistence scope; and
enforcing that respective values of said one or more security properties are stored based on said corresponding persistence scope when said integration connector is operative.

3. The method of claim 2, wherein said pre-defined set of flows comprises an initialization flow, a provide consent flow, a provide consent callback flow, a validate context flow, an update ephemerals flow, and an apply flow.

4. The method of claim 3, wherein said security policy is token-based,
wherein said provide consent flow and said provide consent callback flow facilitate generation of a token,
wherein said validate context flow and said update ephemerals flow facilitate management of said token, and
wherein said apply flow injects said token in each request sent by said integration connector to said target component.

5. The method of claim 3, wherein said corresponding persistence scope is one of a connection scope, a request scope and a session scope,
wherein said ensuring comprises checking that security properties associated with only said request scope or said session scope are updated in said validate context flow and said update ephemerals flow, and that no security properties are updated in said apply flow.

6. The method of claim 5, wherein said enforcing comprises creating one or more instructions, which when operative, causes said respective values of said one or more security properties associated with said connection scope to be stored in a vault, and those associated with said session scope to be stored in an ephemeral store,
wherein said generating incorporates said one or more instructions in said integration connector.

7. The method of claim 6, wherein each security property is one of:
a fixed type whose value is pre-defined by a connector developer;
an inferred type whose value is determined based on other security properties;
an input type whose value is provided by an integration developer;
a volatile type whose value is computed afresh for each request; and
an ephemeral type whose value is to be refreshed after every expiry duration,
wherein said fixed type, said inferred type and said input type are associated with said connection scope, said volatile type is associated with said request scope, and said ephemeral type is associated with said session scope.

8. The method of claim 1, wherein said forming comprises:
maintaining a library of functions, wherein each function is associated with a corresponding function identifier;
determining a set of function identifiers specified in said respective set of actions; and
including in said software instructions, functions corresponding to said set of function identifiers.

9. A non-transitory machine-readable medium storing one or more sequences of instructions for facilitating development of integration connectors, wherein execution of said one or more instructions by one or more processors contained in a digital processing system cause said digital processing system to perform the actions of:
receiving a metadata corresponding to a security policy for accessing a target component, said metadata specifying a respective set of actions to be performed for each flow of a pre-defined set of flows for implementing said security policy;
inspecting said metadata to identify said respective set of actions;
forming software instructions corresponding to said respective sets of actions; and
generating an integration connector incorporating said software instructions, wherein said integration connector, when operative, implements said security policy in accessing said target component.

10. The non-transitory machine-readable medium of claim 9, further comprising one or more instructions for:
identifying one or more security properties specified in said metadata, each security property being specified associated with a corresponding persistence scope;
ensuring that any update to said one or more security properties in said pre-defined set of flows specified by said metadata is consistent with said corresponding persistence scope; and
enforcing that respective values of said one or more security properties are stored based on said corresponding persistence scope when said integration connector is operative.

11. The non-transitory machine-readable medium of claim 10, wherein said pre-defined set of flows comprises an initialization flow, a provide consent flow, a provide consent callback flow, a validate context flow, an update ephemerals flow, and an apply flow.

12. The non-transitory machine-readable medium of claim 11, wherein said corresponding persistence scope is one of a connection scope, a request scope and a session scope,
wherein said ensuring comprises checking that security properties associated with only said request scope or said session scope are updated in said validate context flow and said update ephemerals flow, and that no security properties are updated in said apply flow.

13. The non-transitory machine-readable medium of claim 12, wherein said enforcing comprises creating one or more instructions, which when operative, causes said respective values of said one or more security properties associated with said connection scope to be stored in a vault, and those associated with said session scope to be stored in an ephemeral store,
wherein said generating incorporates said one or more instructions in said integration connector.

14. The non-transitory machine-readable medium of claim 9, wherein said forming comprises one or more instructions for:
maintaining a library of functions, wherein each function is associated with a corresponding function identifier;
determining a set of function identifiers specified in said respective set of actions; and
including in said software instructions, functions corresponding to said set of function identifiers.

15. A digital processing system comprising:
a random access memory (RAM) to store instructions for facilitating development of integration connectors; and
one or more processors to retrieve and execute the instructions, wherein execution of the instructions causes the digital processing system to perform the actions of:
receiving a metadata corresponding to a security policy for accessing a target component, said metadata specifying a respective set of actions to be performed for each flow of a pre-defined set of flows for implementing said security policy;
inspecting said metadata to identify said respective set of actions;
forming software instructions corresponding to said respective sets of actions; and
generating an integration connector incorporating said software instructions, wherein said integration connector, when operative, implements said security policy in accessing said target component.

16. The digital processing system of claim 15, further performing the actions of:
identifying one or more security properties specified in said metadata, each security property being specified associated with a corresponding persistence scope;
ensuring that any update to said one or more security properties in said pre-defined set of flows specified by said metadata is consistent with said corresponding persistence scope; and
enforcing that respective values of said one or more security properties are stored based on said corresponding persistence scope when said integration connector is operative.

17. The digital processing system of claim 16, wherein said pre-defined set of flows comprises an initialization flow, a provide consent flow, a provide consent callback flow, a validate context flow, an update ephemerals flow, and an apply flow.

18. The digital processing system of claim 17, wherein said corresponding persistence scope is one of a connection scope, a request scope and a session scope,
wherein said ensuring comprises checking that security properties associated with only said request scope or said session scope are updated in said validate context flow and said update ephemerals flow, and that no security properties are updated in said apply flow.

19. The digital processing system of claim 18, wherein said enforcing comprises creating one or more instructions, which when operative, causes said respective values of said one or more security properties associated with said connection scope to be stored in a vault, and those associated with said session scope to be stored in an ephemeral store,
wherein said generating incorporates said one or more instructions in said integration connector.

20. The digital processing system of claim 15, wherein for said forming, said digital processing system performs the actions of:
maintaining a library of functions, wherein each function is associated with a corresponding function identifier;
determining a set of function identifiers specified in said respective set of actions; and
including in said software instructions, functions corresponding to said set of function identifiers.
